(19) United States
(12) Patent Application Publication
(10) Pub. No.: US 2023/0415981 A1
(43) Pub. Date: Dec. 28, 2023

(54) REFUSE VEHICLE WITH A CAMERA FOR CONTAINER AREA IMAGE CAPTURE

(71) Applicant: Oshkosh Corporation, Oshkosh, WI (US)

(72) Inventors: Amanda Miller, Oshkosh, WI (US); Greg Steffens, Oshkosh, WI (US); Brendan Chan, Oshkosh, WI (US); Jeff Verhagen, Oshkosh, WI (US)

(21) Appl. No.: 18/342,597

(22) Filed: Jun. 27, 2023

Related U.S. Application Data
(60) Provisional application No. 63/356,162, filed on Jun. 28, 2022.

(51) Int. Cl. B65F 3/02; B60R 11/04; B60W 50/14

(52) U.S. Cl. CPC B65F 3/02; B60R 11/04; B60W 50/14; B65F 2210/168; B60W 2420/42; B60R 2300/80; B60Y 2200/144

(57) ABSTRACT

A method of operating a refuse vehicle includes capturing an image of a target area. The target area includes a collection exception that prevents lifting of a refuse container from the target area at the location. The method further includes classifying the collection exception and including the classified collection exception in collection data, and transmitting the image of the target area and the collection data to a remote server or cloud platform.

### CROSS-REFERENCE TO RELATED PATENT APPLICATIONS

This application claims the benefit of and priority to U.S. Provisional Application No. 63/356,162, filed on Jun. 28, 2022, the entire disclosure of which is hereby incorporated by reference herein.

### BACKGROUND

The present disclosure relates generally to vehicles. More specifically, the present disclosure relates to a refuse vehicle that travels from location to location to pick and transport refuse from refuse containers along a travel route.

### SUMMARY

One embodiment relates to a method of operating a refuse vehicle. The method includes traveling to a location and capturing an image of a target area. The target area includes a collection exception that prevents lifting of a refuse container from the target area at the location. The method further includes classifying the collection exception and including the classified collection exception in collection data, and transmitting the image of the target area and the collection data to a remote server or cloud platform.

Another embodiment relates to a refuse vehicle that includes a chassis, a cab coupled to the chassis, a refuse compartment supported chassis and having a storage section and a hopper section arranged between the cab and the storage section, a lift assembly operable to engage and lift a refuse container, a camera coupled to a portion of the cab or the refuse compartment, and a controller having a processor and at least one memory. The controller being in communication with the camera and configured to instruct the camera to capture an image of a target area in response to an image capture input, and transmit the image and a collection exception to a remote server or cloud platform.

Another embodiment relates to a refuse vehicle that includes a method of operating a refuse vehicle. The method includes traveling along a planned route and capturing an image of a target area in response to: activating a camera to capture the image of the target area; detecting that the refuse vehicle did not stop at a predefined stopping location along the planned route; or detecting that the refuse vehicle stopped at the predefined stopping location and failed to actuate a lift assembly. The method further includes classifying a collection exception in the image as: a refuse container not being present at the predefined stopping location, a refuse container being present at the predefined stopping location and overflowing; or a refuse container being irretrievable from the predefined stopping location. The method further includes transmitting the image of the target area and the collection data to a remote server or cloud platform.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a left side view of a vehicle, according to an exemplary embodiment.

FIG. 2 is a perspective view of a chassis of the vehicle of FIG. 1.

FIG. 3 is a perspective view of the vehicle of FIG. 1 configured as a front-loading refuse vehicle, according to an exemplary embodiment.

FIG. 4 is a left side view of the front-loading refuse vehicle of FIG. 3 configured with a tag axle.

FIG. 5 is a perspective view of the vehicle of FIG. 1 configured as a side-loading refuse vehicle, according to an exemplary embodiment.

FIG. 6 is a right side view of the side-loading refuse vehicle of FIG. 5.

FIG. 7 is a top view of the side-loading refuse vehicle of FIG. 5.

FIG. 8 is a left side view of the side-loading refuse vehicle of FIG. 5 configured with a tag axle.

FIG. 9 is a perspective view of the vehicle of FIG. 1 configured as a mixer vehicle, according to an exemplary embodiment.

FIG. 10 is a perspective view of the vehicle of FIG. 1 configured as a fire fighting vehicle, according to an exemplary embodiment.

FIG. 11 is a left side view of the vehicle of FIG. 1 configured as an airport fire fighting vehicle, according to an exemplary embodiment.

FIG. 12 is a perspective view of the vehicle of FIG. 1 configured as a boom lift, according to an exemplary embodiment.

FIG. 13 is a perspective view of the vehicle of FIG. 1 configured as a scissor lift, according to an exemplary embodiment.

FIG. 14 is a schematic illustration of a top view of the front-loading refuse vehicle of FIG. 3 or FIG. 4 including a camera arranged within a cab, according to an exemplary embodiment.

FIG. 15 is a schematic illustration of a top view of the front-loading refuse vehicle of FIG. 3 or FIG. 4 including a camera arranged mounted to a right sidewall, according to an exemplary embodiment.

FIG. 16 is a schematic illustration of a top view of the front-loading refuse vehicle of FIG. 3 or FIG. 4 including a camera arranged mounted to a left sidewall, according to an exemplary embodiment.

FIG. 17 is a left side view of the front-loading refuse vehicle of FIG. 4 including a camera arranged within a cab, according to an exemplary embodiment.

FIG. 18 is a perspective view the front-loading refuse vehicle of FIG. 3 including a camera mounted to a sidewall, according to an exemplary embodiment.

FIG. 19 is a right side view of the side-loading refuse vehicle of FIG. 5 including a camera mounted to a cab, according to an exemplary embodiment.

FIG. 20 is a top view of the side-loading refuse vehicle of FIG. 19.

FIG. 21 a right side view of the side-loading refuse vehicle of FIG. 5 including a camera mounted to a hopper section of a refuse compartment, according to an exemplary embodiment.

FIG. 22 is a top view of the side-loading refuse vehicle of FIG. 21.

FIG. 23 is a right side view of the side-loading refuse vehicle of FIG. 5 including a camera mounted to a storage section of a refuse compartment, according to an exemplary embodiment.

FIG. 24 is a top view of the side-loading refuse vehicle of FIG. 23.

FIG. 25 is a block diagram of a control panel in communication with a camera, according to an exemplary embodiment.

FIG. 26 is a block diagram of a controller of the control panel of FIG. 25, according to an exemplary embodiment.

FIG. 27 is a flow chart illustrating a method of operating a refuse vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle (e.g., a refuse vehicle) includes a camera that is configured to capture an image of a target area in a location. The target area is expected to include a refuse container (e.g., dumpster, garbage can, etc.) and the camera is configured to capture an image of the target area to verify and document a collection exception. A collection exception can be classified as a refuse container overflowing, a refuse container not being present in the target area, a refuse container being irretrievable, or an equivalent status that prevents the vehicle from lifting a refuse container from the target area. In some embodiments, the collection exception is classified and included in collection data that is sent with a captured image to a remote server or cloud platform in communication with the vehicle. In this way, for example, the collection exceptions along a planned route traveled by the vehicle are stored and documented for viewing by a user at a remote location.

In some embodiments, the camera is configured to capture an image of the target area in response to a user instructing the camera to capture an image (e.g., via a push button or another manual input provided by a user). In some embodiments, the camera is configured to automatically capture an image of the target area in response to one or more actions by the vehicle. For example, the camera can be configured to automatically capture an image in response to detecting that the vehicle did not stop at a predefined picking location defined by a route plan or route history. Alternatively or additionally, the camera can be configured to automatically capture an image in response to detecting that the vehicle made a stop but a lift assembly was not actuated (i.e., the vehicle stopped but no refuse container was lifted).

### Overall Vehicle

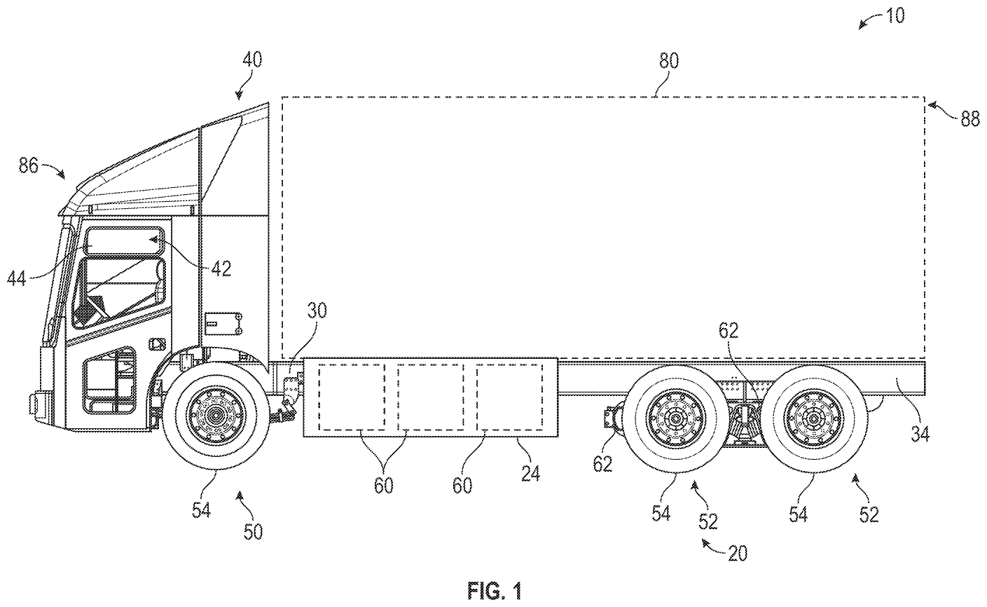

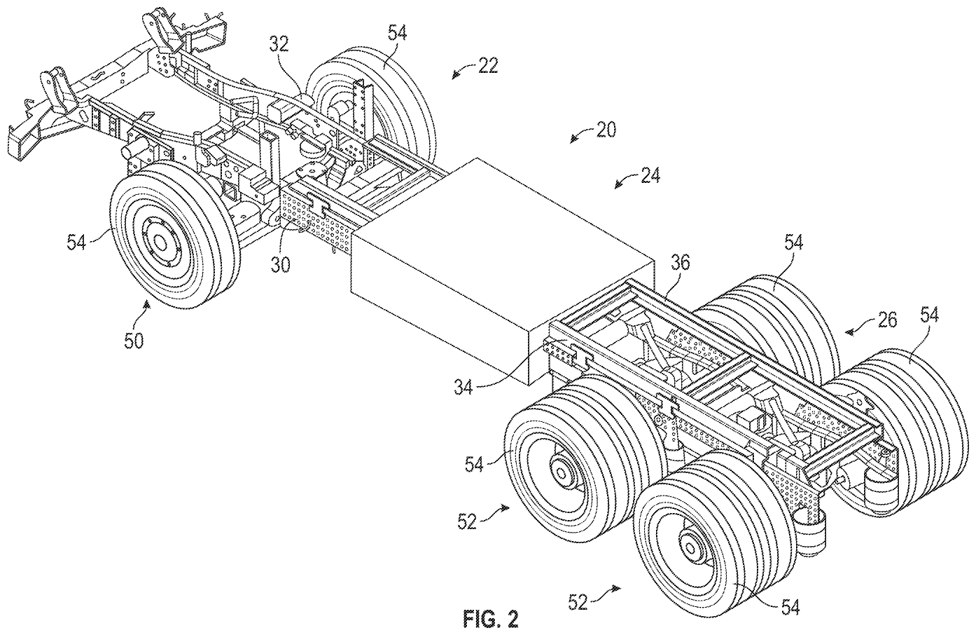

Referring to FIGS. 1 and 2, a reconfigurable vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the axle front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

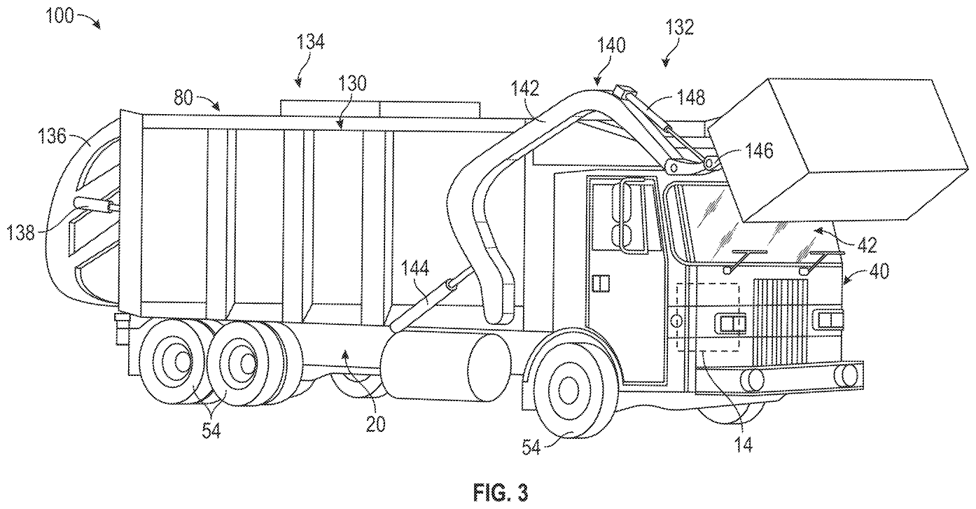

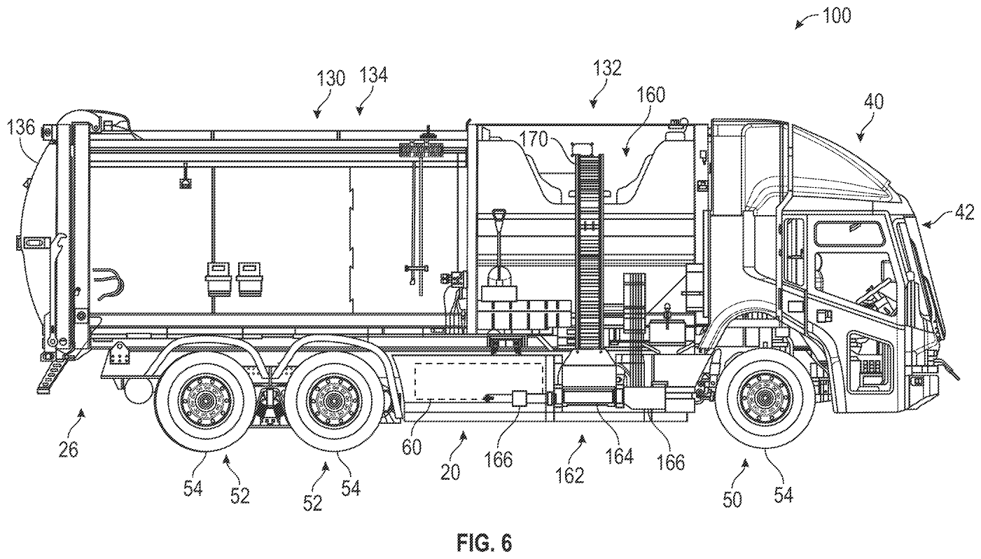

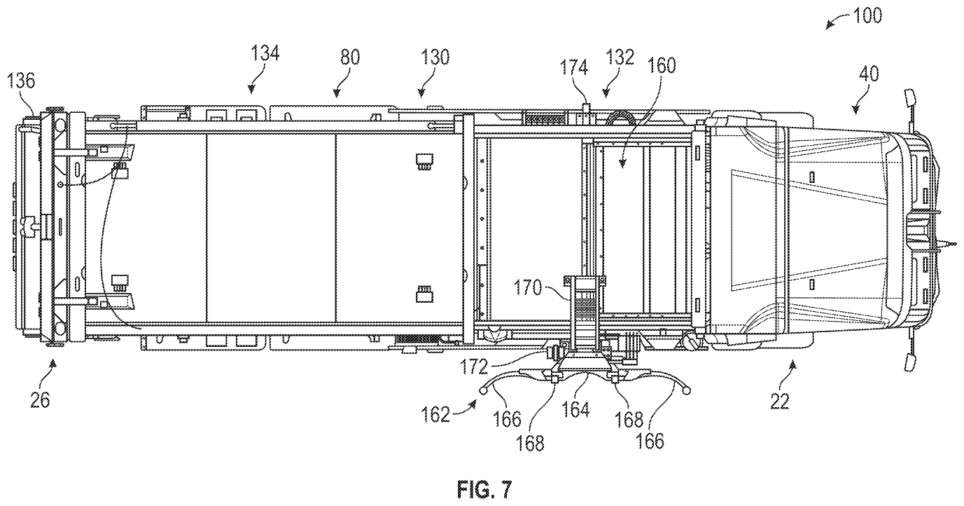

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-13 illustrate various examples of how the vehicle 10 may be configured for specific applications. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

### A. Front-Loading Refuse Vehicle

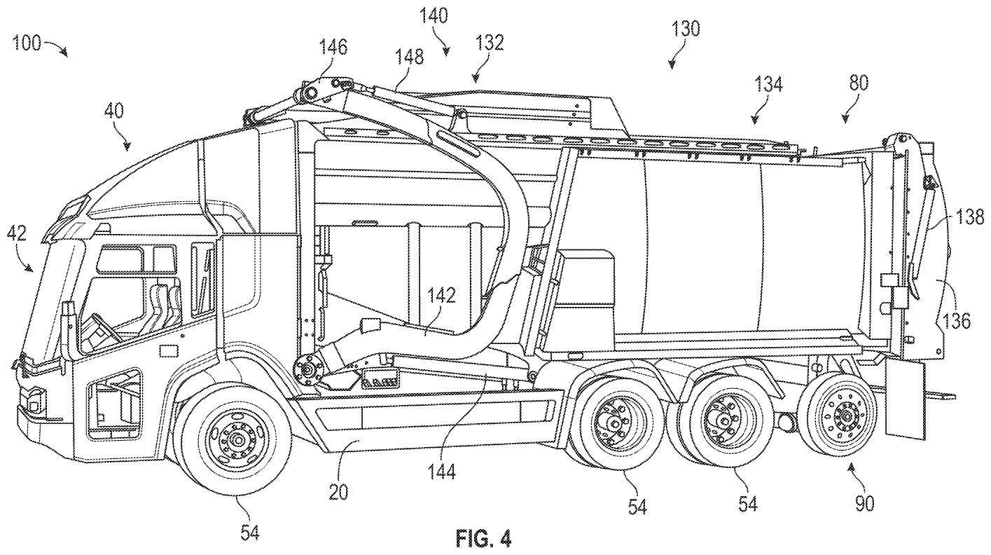

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a front-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned reward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck). As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively coupled the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

### B. Side-Loading Refuse Vehicle

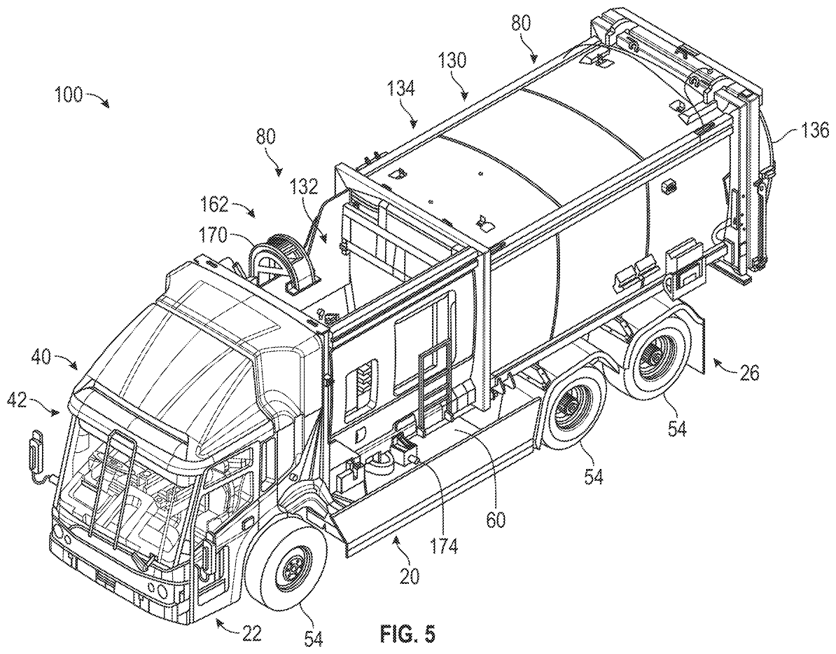

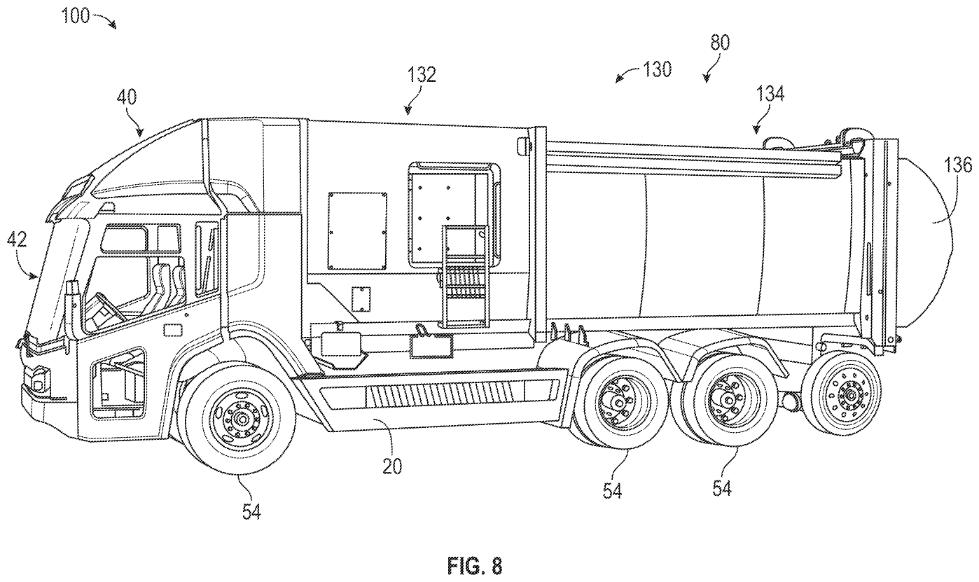

Referring now to FIGS. 5-8, an alternative configuration of the refuse vehicle 100 is shown according to an exemplary embodiment. Specifically, the refuse vehicle 100 of FIGS. 5-8 is configured as a side-loading refuse vehicle. The refuse vehicle 100 of FIGS. 5-8 may be substantially similar to the front-loading refuse vehicle 100 of FIGS. 3 and 4 except as otherwise specified herein. As shown, the refuse vehicle 100 of FIGS. 5-7 is configured with a tag axle 90 in FIG. 8.

Referring still to FIGS. 5-8, the refuse vehicle 100 omits the lift assembly 140 and instead includes a side-loading lift assembly, shown as lift assembly 160, that extends laterally outward from a side of the refuse vehicle 100. The lift assembly 160 includes an interface assembly, shown as grabber assembly 162, that is configured to engage a refuse container (e.g., a residential garbage can) to selectively couple the refuse container to the lift assembly 160. The grabber assembly 162 includes a main portion, shown as main body 164, and a pair of fingers or interface members, shown as grabber fingers 166. The grabber fingers 166 are pivotally coupled to the main body 164 such that the grabber fingers 166 are each rotatable about a vertical axis. A pair of actuators (e.g., hydraulic motors, electric motors, etc.), shown as finger actuators 168, are configured to control movement of the grabber fingers 166 relative to the main body 164.

The grabber assembly 162 is movably coupled to a guide, shown as track 170, that extends vertically along a side of the refuse vehicle 100. Specifically, the main body 164 is slidably coupled to the track 170 such that the main body 164 is repositionable along a length of the track 170. An actuator (e.g., a hydraulic motor, an electric motor, etc.), shown as lift actuator 172, is configured to control movement of the grabber assembly 162 along the length of the track 170. In some embodiments, a bottom end portion of the track 170 is straight and substantially vertical such that the grabber assembly 162 raises or lowers a refuse container when moving along the bottom end portion of the track 170. In some embodiments, a top end portion of the track 170 is curved such that the grabber assembly 162 inverts a refuse container to dump refuse into the hopper volume 132 when moving along the top end portion of the track 170.

The lift assembly 160 further includes an actuator (e.g., a hydraulic cylinder, an electric linear actuator, etc.), shown as track actuator 174, that is configured to control lateral movement of the grabber assembly 162. By way of example, the track actuator 174 may be coupled to the chassis 20 and the track 170 such that the track actuator 174 moves the track 170 and the grabber assembly 162 laterally relative to the chassis 20. The track actuator 174 may facilitate repositioning the grabber assembly 162 to pick up and replace refuse containers that are spaced laterally outward from the refuse vehicle 100.

### C. Concrete Mixer Truck

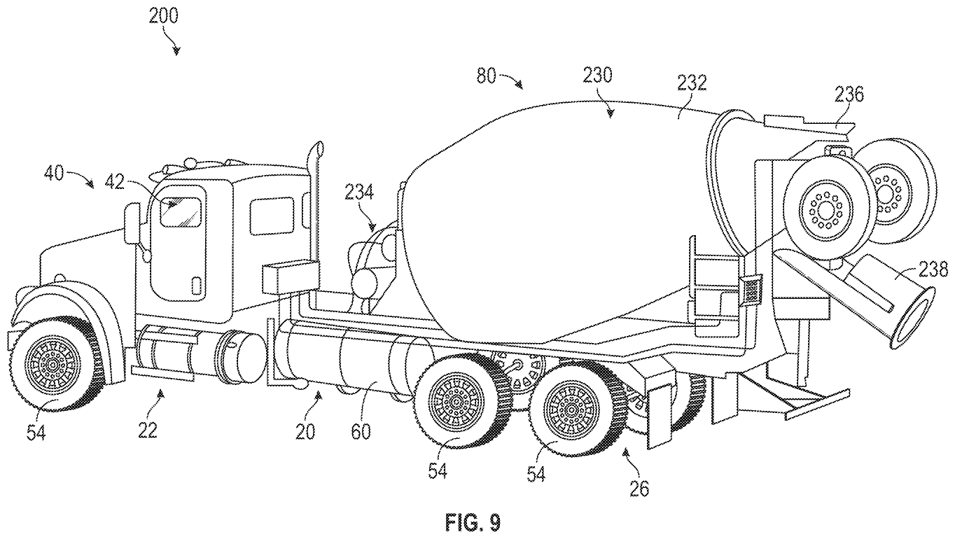

Referring now to FIG. 9, the vehicle 10 is configured as a mixer truck (e.g., a concrete mixer truck, a mixer vehicle, etc.), shown as mixer truck 200. Specifically, the mixer truck 200 is shown as a rear-discharge concrete mixer truck. In other embodiments, the mixer truck 200 is a front-discharge concrete mixer truck.

As shown in FIG. 9, the application kit 80 includes a mixing drum assembly (e.g., a concrete mixing drum), shown as drum assembly 230. The drum assembly 230 may include a mixing drum 232, a drum drive system 234 (e.g., a rotational actuator or motor, such as an electric motor or hydraulic motor), an inlet portion, shown as hopper 236, and an outlet portion, shown as chute 238. The mixing drum 232 may be coupled to the chassis 20 and may be disposed behind the cab 40 (e.g., at the rear and/or middle of the chassis 20). In an exemplary embodiment, the drum drive system 234 is coupled to the chassis 20 and configured to selectively rotate the mixing drum 232 about a central, longitudinal axis. According to an exemplary embodiment, the central, longitudinal axis of the mixing drum 232 may be elevated from the chassis 20 (e.g., from a horizontal plane extending along the chassis 20) at an angle in the range of five degrees to twenty degrees. In other embodiments, the central, longitudinal axis may be elevated by less than five degrees (e.g., four degrees, etc.). In yet another embodiment, the mixer truck 200 may include an actuator positioned to facilitate adjusting the central, longitudinal axis to a desired or target angle (e.g., manually in response to an operator input/command, automatically according to a control system, etc.).

The mixing drum 232 may be configured to receive a mixture, such as a concrete mixture (e.g., cementitious material, aggregate, sand, etc.), through the hopper 236. In some embodiments, the mixer truck 200 includes an injection system (e.g., a series of nozzles, hoses, and/or valves) including an injection valve that selectively fluidly couples a supply of fluid to the inner volume of the mixing drum 232. By way of example, the injection system may be used to inject water and/or chemicals (e.g., air entrainers, water reducers, set retarders, set accelerators, superplasticizers, corrosion inhibitors, coloring, calcium chloride, minerals, and/or other concrete additives, etc.) into the mixing drum 232. The injection valve may facilitate injecting water and/or chemicals from a fluid reservoir (e.g., a water tank, etc.) into the mixing drum 232, while preventing the mixture in the mixing drum 232 from exiting the mixing drum 232 through the injection system. In some embodiments, one or more mixing elements (e.g., fins, etc.) may be positioned in the interior of the mixing drum 232, and may be configured to agitate the contents of the mixture when the mixing drum 232 is rotated in a first direction (e.g., counterclockwise, clockwise, etc.), and drive the mixture out through the chute 238 when the mixing drum 232 is rotated in a second direction (e.g., clockwise, counterclockwise, etc.). In some embodiments, the chute 238 may also include an actuator positioned such that the chute 238 may be selectively pivotable to position the chute 238 (e.g., vertically, laterally, etc.), for example at an angle at which the mixture is expelled from the mixing drum 232.

### D. Fire Truck

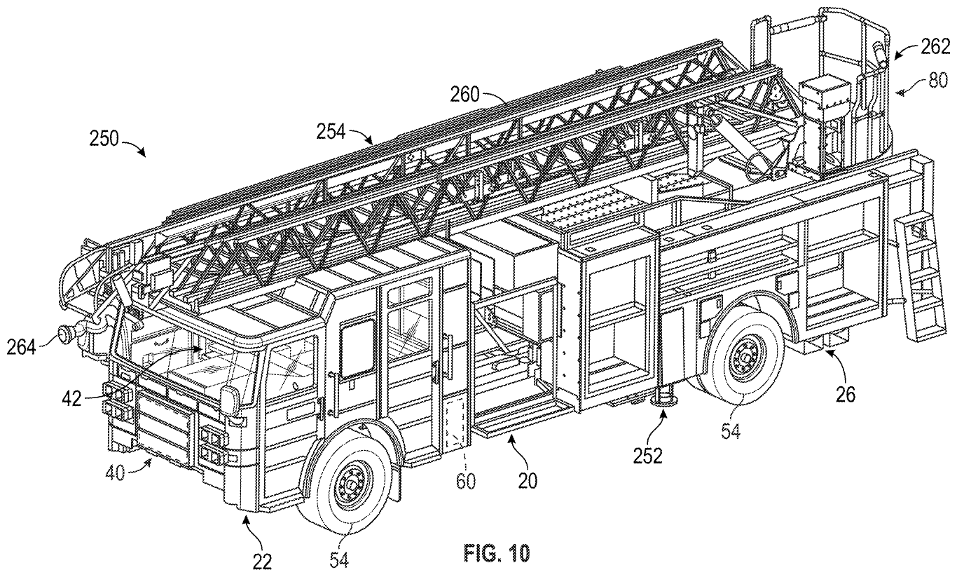

Referring now to FIG. 10, the vehicle 10 is configured as a fire fighting vehicle, fire truck, or fire apparatus (e.g., a turntable ladder truck, a pumper truck, a quint, etc.), shown as fire fighting vehicle 250. In the embodiment shown in FIG. 10, the fire fighting vehicle 250 is configured as a rear-mount aerial ladder truck. In other embodiments, the fire fighting vehicle 250 is configured as a mid-mount aerial ladder truck, a quint fire truck (e.g., including an on-board water storage, a hose storage, a water pump, etc.), a tiller fire truck, a pumper truck (e.g., without an aerial ladder), or another type of response vehicle. By way of example, the vehicle 10 may be configured as a police vehicle, an ambulance, a tow truck, or still other vehicles used for responding to a scene (e.g., an accident, a fire, an incident, etc.).

As shown in FIG. 10, in the fire fighting vehicle 250, the application kit 80 is positioned mainly rearward from the cab 40. The application kit 80 includes deployable stabilizers (e.g., outriggers, downriggers, etc.), shown as outriggers 252, that are coupled to the chassis 20. The outriggers 252 may be configured to selectively extend from each lateral side and/or the rear of the fire fighting vehicle 250 and engage a support surface (e.g., the ground) in order to provide increased stability while the fire fighting vehicle 250 is stationary. The fire fighting vehicle 250 further includes an extendable or telescoping ladder assembly, shown as ladder assembly 254. The increased stability provided by the outriggers 252 is desirable when the ladder assembly 254 is in use (e.g., extended from the fire fighting vehicle 250) to prevent tipping. In some embodiments, the application kit 80 further includes various storage compartments (e.g., cabinets, lockers, etc.) that may be selectively opened and/or accessed for storage and/or component inspection, maintenance, and/or replacement.

As shown in FIG. 10, the ladder assembly 254 includes a series of ladder sections 260 that are slidably coupled with one another such that the ladder sections 260 may extend and/or retract (e.g., telescope) relative to one another to selectively vary a length of the ladder assembly 254. A base platform, shown as turntable 262, is rotatably coupled to the chassis 20 and to a proximal end of a base ladder section 260 (i.e., the most proximal of the ladder sections 260). The turntable 262 may be configured to rotate about a vertical axis relative to the chassis 20 to rotate the ladder sections 260 about the vertical axis (e.g., up to 360 degrees, etc.). The ladder sections 260 may rotate relative to the turntable 262 about a substantially horizontal axis to selectively raise and lower the ladder sections 260 relative to the chassis 20. As shown, a water turret or implement, shown as monitor 264, is coupled to a distal end of a fly ladder section 260 (i.e., the most distal of the ladder sections 260). The monitor 264 may be configured to expel water and/or a fire suppressing agent (e.g., foam, etc.) from a water storage tank and/or an agent tank onboard the fire fighting vehicle 250, and/or from an external source (e.g., a fire hydrant, a separate water/pumper truck, etc.). In some embodiments, the ladder assembly 254 further includes an aerial platform coupled to the distal end of the fly ladder section 260 and configured to support one or more operators.

### E. ARFF Truck

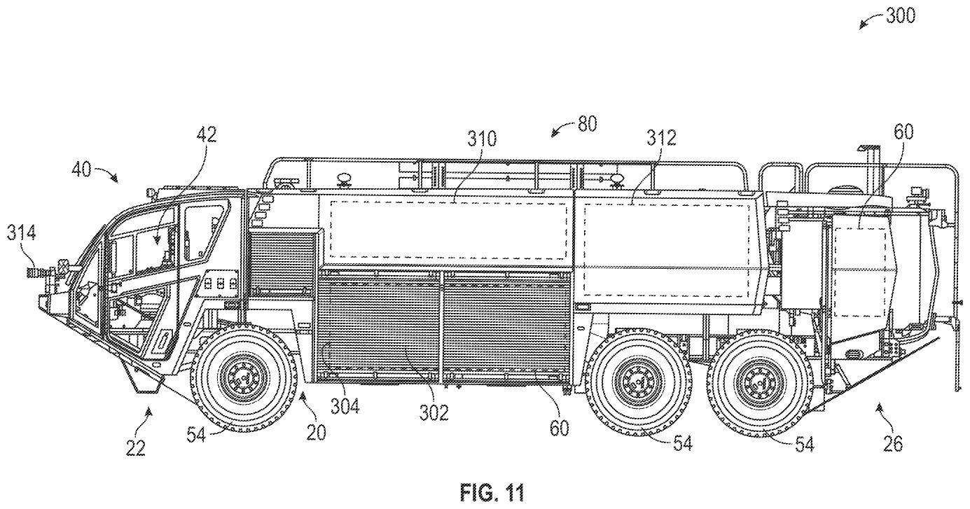

Referring now to FIG. 11, the vehicle 10 is configured as a fire fighting vehicle, shown as airport rescue and fire fighting (ARFF) truck 300. As shown in FIG. 11, the application kit 80 is positioned primarily rearward of the cab 40. As shown, the application kit 80 includes a series of storage compartments or cabinets, shown as compartments 302, that are coupled to the chassis 20. The compartments 302 may store various equipment or components of the ARFF truck 300.

The application kit 80 includes a pump system 304 (e.g., an ultra-high-pressure pump system, etc.) positioned within one of the compartments 302 near the center of the ARFF truck 300. The application kit 80 further includes a water tank 310, an agent tank 312, and an implement or water turret, shown as monitor 314. The pump system 304 may include a high pressure pump and/or a low pressure pump, which may be fluidly coupled to the water tank 310 and/or the agent tank 312. The pump system 304 may to pump water and/or fire suppressing agent from the water tank 310 and the agent tank 312, respectively, to the monitor 314. The monitor 314 may be selectively reoriented by an operator to adjust a direction of a stream of water and/or agent. As shown in FIG. 11, the monitor 314 is coupled to a front end of the cab 40.

### F. Boom Lift

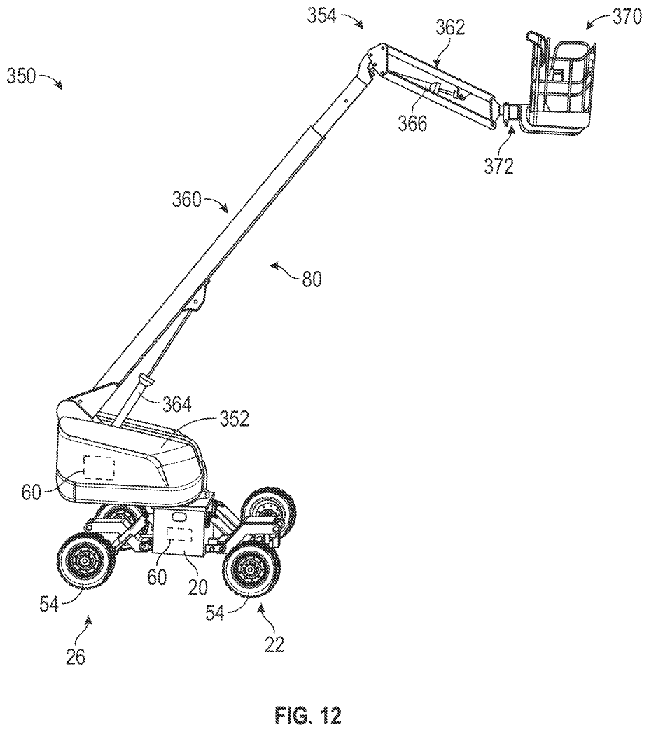

Referring now to FIG. 12, the vehicle 10 is configured as a lift device, shown as boom lift 350. The boom lift 350 may be configured to support and elevate one or more operators. In other embodiments, the vehicle 10 is configured as another type of lift device that is configured to lift operators and/or material, such as a skid-loader, a telehandler, a scissor lift, a fork lift, a vertical lift, and/or any other type of lift device or machine.

As shown in FIG. 12, the application kit 80 includes a base assembly, shown as turntable 352, that is rotatably coupled to the chassis 20. The turntable 352 may be configured to selectively rotate relative to the chassis 20 about a substantially vertical axis. In some embodiments, the turntable 352 includes a counterweight (e.g., the batteries) positioned near the rear of the turntable 352. The turntable 352 is rotatably coupled to a lift assembly, shown as boom assembly 354. The boom assembly 354 includes a first section or telescoping boom section, shown as lower boom 360. The lower boom 360 includes a series of nested boom sections that extend and retract (e.g., telescope) relative to one another to vary a length of the boom assembly 354. The boom assembly 354 further includes a second boom section or four bar linkage, shown as upper boom 362. The upper boom 362 may include structural members that rotate relative to one another to raise and lower a distal end of the boom assembly 354. In other embodiments, the boom assembly 354 includes more or fewer boom sections (e.g., one, three, five, etc.) and/or a different arrangement of boom sections.

As shown in FIG. 12, the boom assembly 354 includes a first actuator, shown as lower lift cylinder 364. The lower boom 360 is pivotally coupled (e.g., pinned, etc.) to the turntable 352 at a joint or lower boom pivot point. The lower lift cylinder 364 (e.g., a pneumatic cylinder, an electric linear actuator, a hydraulic cylinder, etc.) is coupled to the turntable 352 at a first end and coupled to the lower boom 360 at a second end. The lower lift cylinder 364 may be configured to raise and lower the lower boom 360 relative to the turntable 352 about the lower boom pivot point.

The boom assembly 354 further includes a second actuator, shown as upper lift cylinder 366. The upper boom 362 is pivotally coupled (e.g., pinned) to the upper end of the lower boom 360 at a joint or upper boom pivot point. The upper lift cylinder 366 (e.g., a pneumatic cylinder, an electric linear actuator, a hydraulic cylinder, etc.) is coupled to the upper boom 362. The upper lift cylinder 366 may be configured to extend and retract to actuate (e.g., lift, rotate, elevate, etc.) the upper boom 362, thereby raising and lowering a distal end of the upper boom 362.

Referring still to FIG. 12, the application kit 80 further includes an operator platform, shown as platform assembly 370, coupled to the distal end of the upper boom 362 by an extension arm, shown as jib arm 372. The jib arm 372 may be configured to pivot the platform assembly 370 about a lateral axis (e.g., to move the platform assembly 370 up and down, etc.) and/or about a vertical axis (e.g., to move the platform assembly 370 left and right, etc.).

The platform assembly 370 provides a platform configured to support one or more operators or users. In some embodiments, the platform assembly 370 may include accessories or tools configured for use by the operators. For example, the platform assembly 370 may include pneumatic tools (e.g., an impact wrench, airbrush, nail gun, ratchet, etc.), plasma cutters, welders, spotlights, etc. In some embodiments, the platform assembly 370 includes a control panel (e.g., a user interface, a removable or detachable control panel, etc.) configured to control operation of the boom lift 350 (e.g., the turntable 352, the boom assembly 354, etc.) from the platform assembly 370 or remotely. In other embodiments, the platform assembly 370 is omitted, and the boom lift 350 includes an accessory and/or tool (e.g., forklift forks, etc.) coupled to the distal end of the boom assembly 354.

### G. Scissor Lift

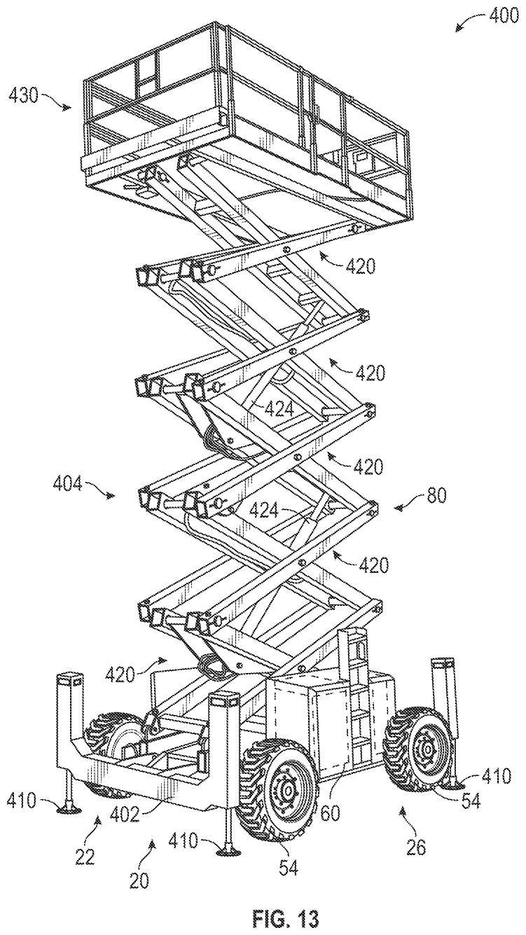

Referring now to FIG. 13, the vehicle 10 is configured as a lift device, shown as scissor lift 400. As shown in FIG. 13, the application kit 80 includes a body, shown as lift base 402, coupled to the chassis 20. The lift base 402 is coupled to a scissor assembly, shown as lift assembly 404, such that the lift base 402 supports the lift assembly 404. The lift assembly 404 is configured to extend and retract, raising and lowering between a raised position and a lowered position relative to the lift base 402.

As shown in FIG. 13, the lift base 402 includes a series of actuators, stabilizers, downriggers, or outriggers, shown as leveling actuators 410. The leveling actuators 410 may extend and retract vertically between a stored position and a deployed position. In the stored position, the leveling actuators 410 may be raised, such that the leveling actuators 410 do not contact the ground. Conversely, in the deployed position, the leveling actuators 410 may engage the ground to lift the lift base 402. The length of each of the leveling actuators 410 in their respective deployed positions may be varied in order to adjust the pitch (e.g., rotational position about a lateral axis) and the roll (e.g., rotational position about a longitudinal axis) of the lift base 402 and/or the chassis 20. Accordingly, the lengths of the leveling actuators 410 in their respective deployed positions may be adjusted to level the lift base 402 with respect to the direction of gravity (e.g., on uneven, sloped, pitted, etc. terrain). The leveling actuators 410 may lift the wheel and tire assemblies 54 off of the ground to prevent movement of the scissor lift 400 during operation. In other embodiments, the leveling actuators 410 are omitted.

The lift assembly 404 may include a series of subassemblies, shown as scissor layers 420, each including a pair of inner members and a pair of outer members pivotally coupled to one another. The scissor layers 420 may be stacked atop one another in order to form the lift assembly 404, such that movement of one scissor layer 420 causes a similar movement in all of the other scissor layers 420. The scissor layers 420 extend between and couple the lift base 402 and an operator platform (e.g., the platform assembly 430). In some embodiments, scissor layers 420 may be added to, or removed from, the lift assembly 404 in order to increase, or decrease, the fully extended height of the lift assembly 404.

Referring still to FIG. 13, the lift assembly 404 may also include one or more lift actuators 424 (e.g., hydraulic cylinders, pneumatic cylinders, electric linear actuators such as motor-driven leadscrews, etc.) configured to extend and retract the lift assembly 404. The lift actuators 424 may be pivotally coupled to inner members of various scissor layers 420, or otherwise arranged within the lift assembly 404.

A distal or upper end of the lift assembly 404 is coupled to an operator platform, shown as platform assembly 430. The platform assembly 430 may perform similar functions to the platform assembly 370, such as supporting one or more operators, accessories, and/or tools. The platform assembly 430 may include a control panel to control operation of the scissor lift 400. The lift actuators 424 may be configured to actuate the lift assembly 404 to selectively reposition the platform assembly 430 between a lowered position (e.g., where the platform assembly 430 is proximate to the lift base 402) and a raised position (e.g., where the platform assembly 430 is at an elevated height relative to the lift base 402). Specifically, in some embodiments, extension of the lift actuators 424 moves the platform assembly 430 upward (e.g., extending the lift assembly 404), and retraction of the lift actuators 424 moves the platform assembly 430 downward (e.g., retracting the lift assembly 404). In other embodiments, extension of the lift actuators 424 retracts the lift assembly 404, and retraction of the lift actuators 424 extends the lift assembly 404.

Refuse Vehicle with a Camera

In general, the refuse vehicles 100 illustrated in FIGS. 3-8 can be equipped with a camera to capture images of a target area where a refuse container is expected to reside. The captured images provide documentation of a collection exception that resulted in a refuse container not being lifted or picked from a target area. For example, a collection exception can be classified as a refuse container overflowing, a refuse container not being present in, or being absent from, a target area, a refuse container being irretrievable, and/or an equivalent status that prevents the refuse vehicle from lifting a refuse container from a target area.

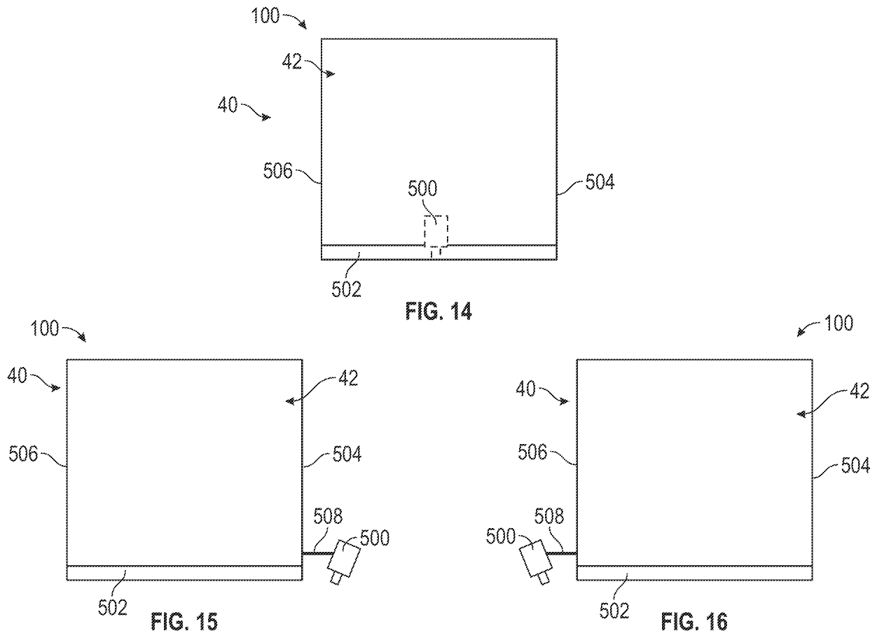

FIGS. 14-18 illustrate embodiments of a camera 500 coupled to the cab 40 of the vehicle 100. In the illustrated embodiments, the camera 500 is forward-facing (e.g., pointing generally parallel to a direction of travel of the vehicle 100) and directed toward a target area for the front-loading configuration of the vehicle 100. That is, the camera 500 is arranged so that a field of view defined by the camera 500 includes a target area where the lift assembly 140 engages and lifts a refuse container.

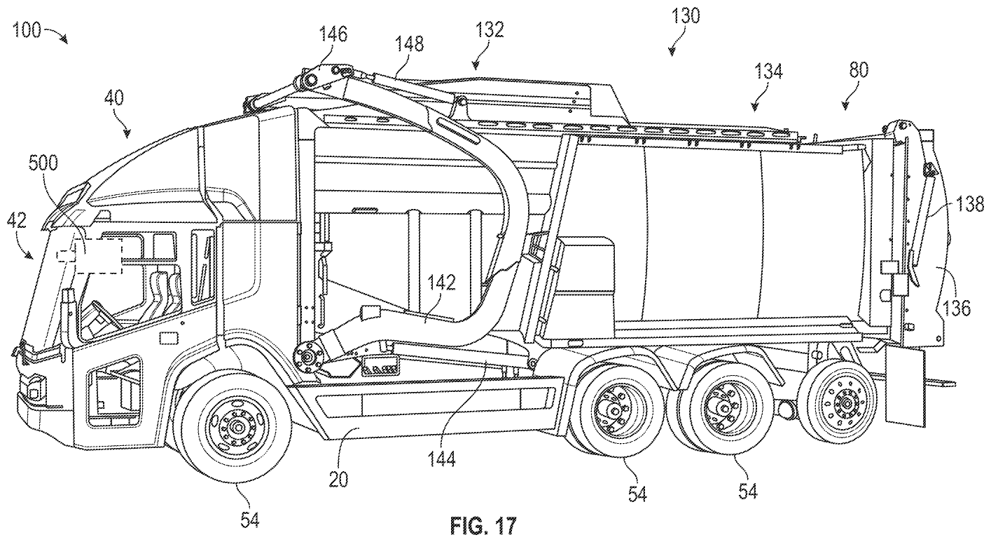

In some embodiments, the camera 500 is integrated into the cab interior 42 (see FIGS. 14 and 17). For example, the camera 500 can be configured as a dash camera that is integrated into or installed on a windshield 502 of the cab 40. In some embodiments, the camera 500 is coupled to an internal surface within the cab interior 42 so that the camera 500 is directed to view a target area where the lift assembly 140 engages and lifts a refuse container.

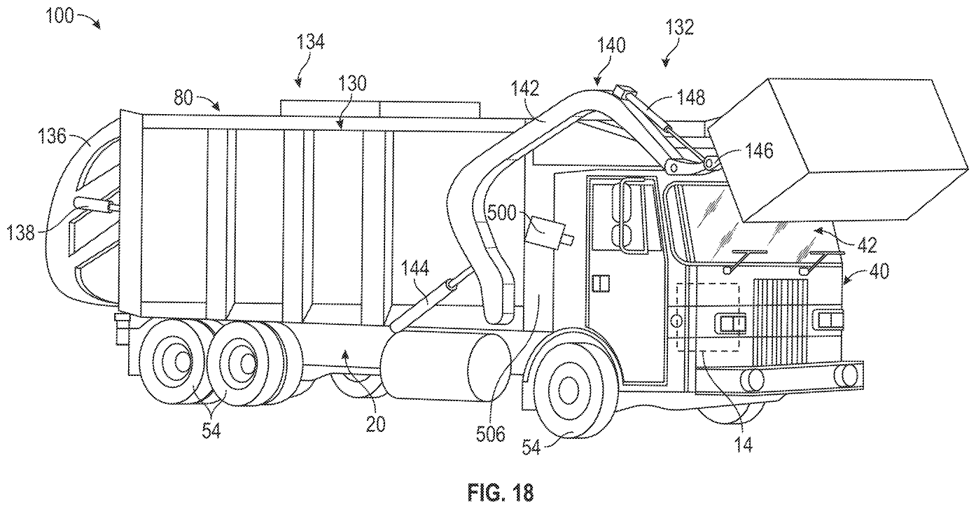

In some embodiments, the camera 500 is coupled to an exterior sidewall of the cab 40. For example, FIG. 15 illustrates the camera 500 being coupled to a left sidewall 504 of the cab 40, and FIGS. 16 and 18 illustrate the camera 500 being coupled to a right sidewall 506 of the cab 40. In some embodiments, the camera 500 is coupled to the cab 40 by a coupling arm 508. The coupling arm 508 is secured to a surface of the cab 40 (e.g., the left sidewall 504, the right sidewall 506, an internal surface of the cab interior 42, or another surface of the cab 40) and supports the camera 500. In some embodiments, the coupling arm 508 can include an actuator that is configured to control/vary a distance that the camera 500 is arranged relative to the respective surface of the cab 40 to which the coupling arm 508 is secured. In some embodiments, the coupling arm 508 includes a rotational actuator that is configured to rotate the camera 500 to adjust the field of view of the camera (e.g., in response to a joystick or another input manipulated by a user of the vehicle 100). The rotational actuator can be controlled by a user of the vehicle 100 to align the field of view defined by the camera 500 with the target area.

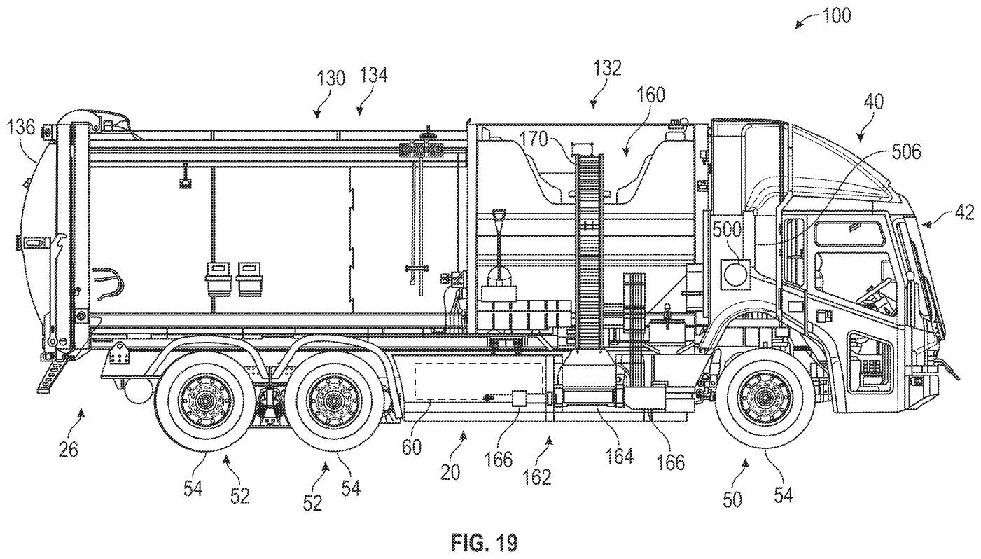

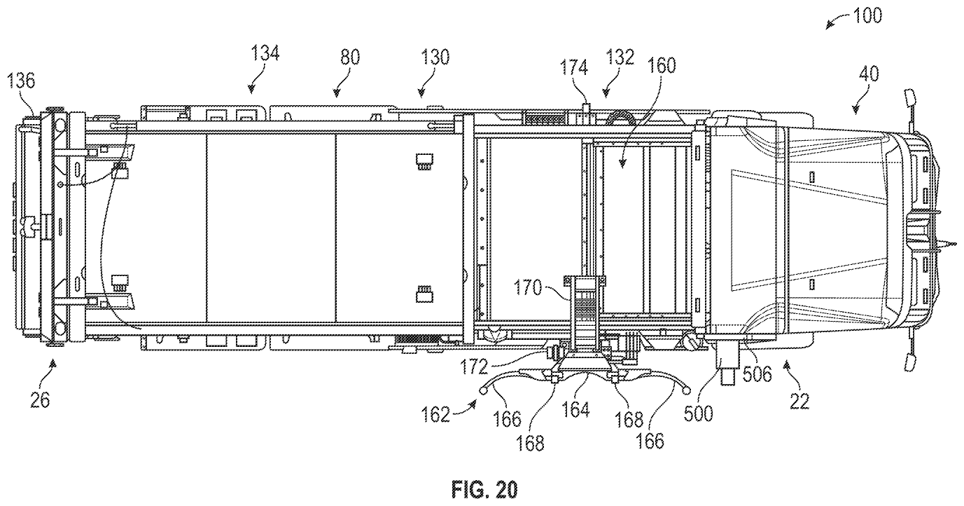

In some embodiments, the camera 500 is coupled to the vehicle 100 in a location so that the field of view of the camera 500 includes a target area for the side-loading configuration of the vehicle 100. For example, FIGS. 19-24 illustrate the camera 500 coupled to the side-loading configuration of the vehicle 100. In general, the camera 500 can be coupled to the same side of the vehicle 100 that the lift assembly 160 extends from. In this way, the camera 500 is directed toward the target area where the lift assembly 160 engages and lifts a refuse container. The camera 500 can be coupled at various locations along the side of the vehicle 100. For example, in some embodiments, the camera 500 is coupled to a sidewall of the cab 40. As shown in FIGS. 19 and 20, the camera 500 is coupled to the right sidewall 506 of the cab 40 (i.e., the side of the vehicle 100 that the lift assembly 160 extends from).

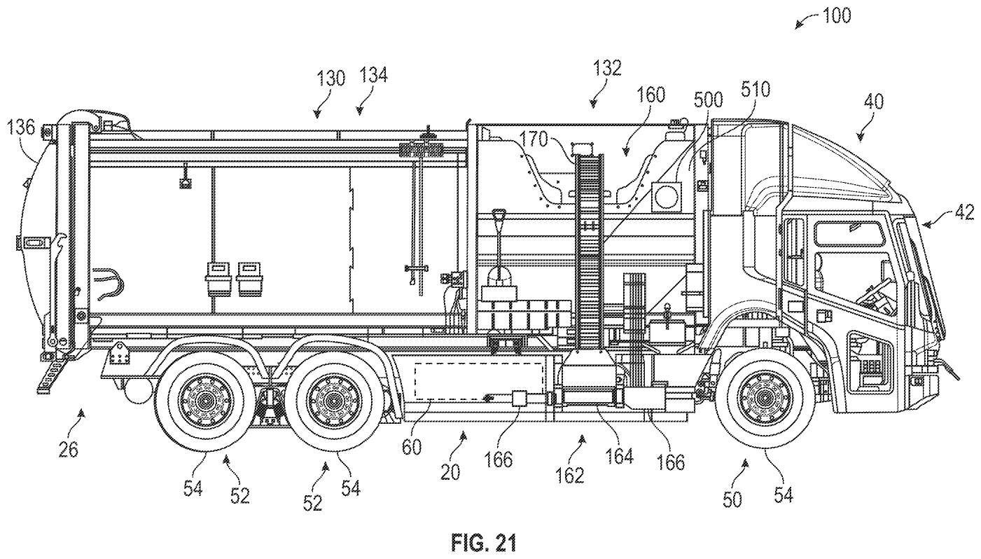

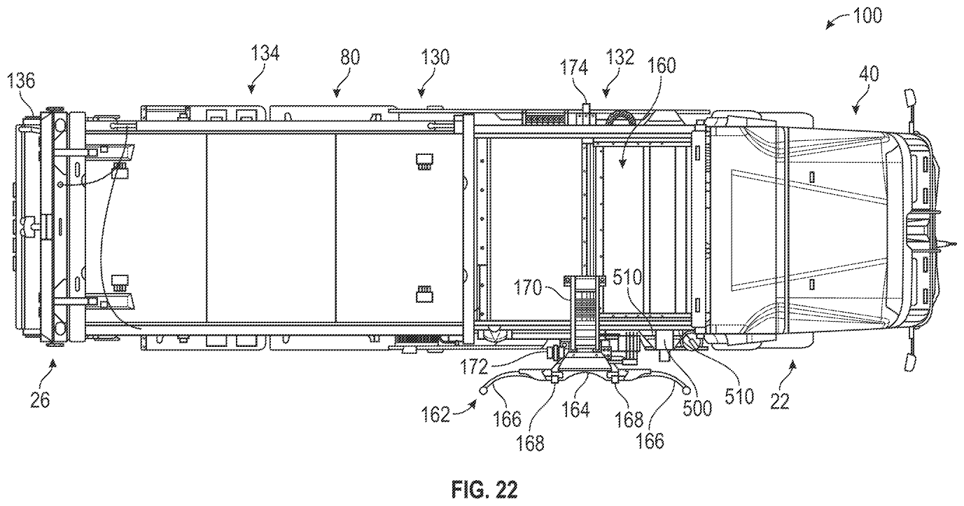

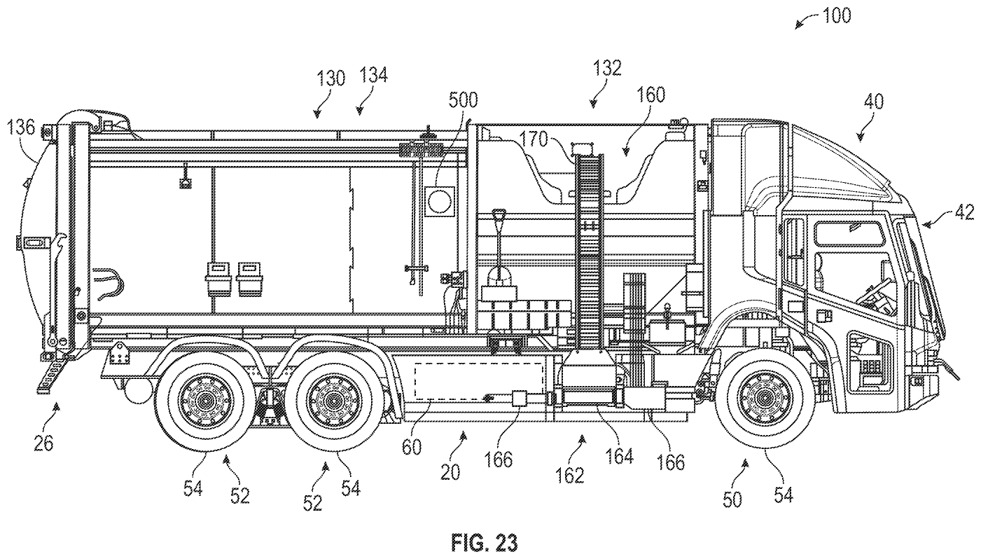

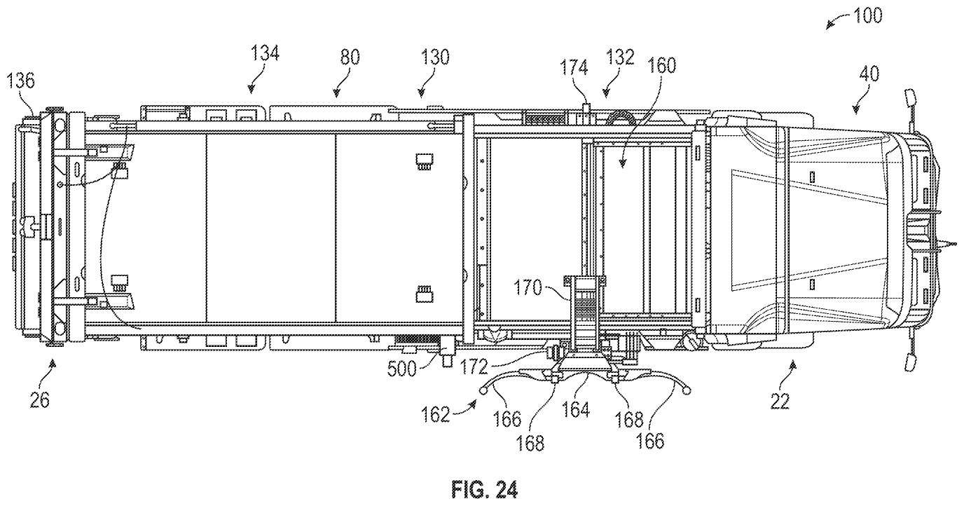

In some embodiments, the camera 500 is coupled to a side of the refuse compartment 130. As shown in FIGS. 21 and 22, the camera 500 is coupled to an external surface 510 of the hopper volume 130 (e.g., a hopper section of the refuse compartment 130). In some embodiments, the camera 500 is coupled to an external surface of the storage volume 134 (e.g., a storage section of the refuse compartment 130), as shown in FIGS. 23 and 24.

In some embodiments, the camera 500 is in the form of a DSLR camera, a CCD camera, a time of flight camera, or any other equivalent camera capable of capturing an image of a target area. Regardless of the specific vehicle configuration and/or the mounting location of the camera 500, the camera 500 is coupled to the vehicle 100 so that that field of view defined by the camera 500 includes the target area where a refuse container is expected to be engaged and lifted by the lift assembly 140, 160. The following description of the functionality and properties of the camera 500 and its associated control applies to all configurations of the vehicle 100 and all mounting locations of the camera 500.

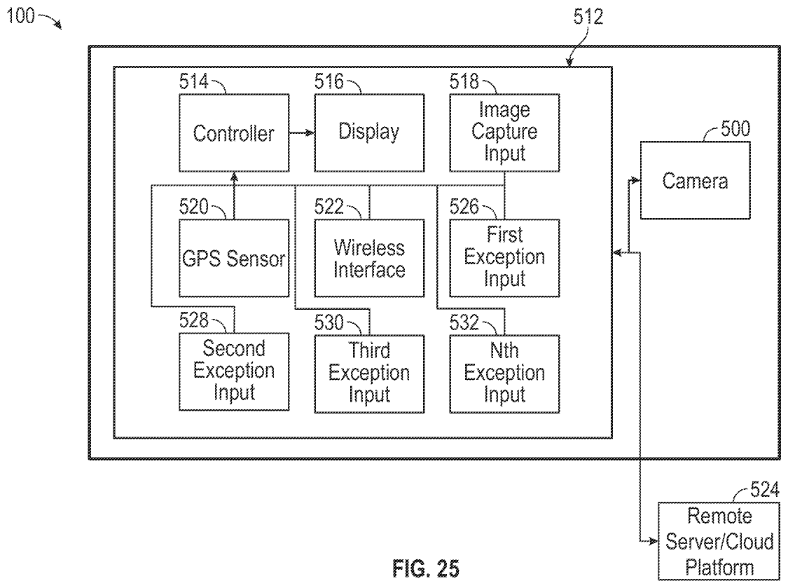

In general, the vehicle 100 includes a control panel 512 that is in communication with the camera 500 and controls the operation thereof. As shown in FIG. 25, the control panel 512 includes a controller 514, a display 516, an image capture input 518, a global positioning system (GPS) sensor 520, and a wireless interface 522. In some embodiments, the controller 514 is the native controller on the vehicle 100 that communicates over a vehicle CAN bus. In some embodiments, the controller 514 is a dedicated controller that is included on the vehicle 100 to control operation of the camera 500. The controller 514 is in communication with the display 516, and the display 516 is in communication with the camera 500. The display 516 is configured to display images captured by the camera 500 and, in some embodiments, the display 516 is configured as a touch screen that includes control functionality for the camera 500 and/or collection data associated with the images captured by the camera 500.

In some embodiments, the image capture input 518 is in the form of a push button, a switch, or an equivalent input that is manipulated by a user of the vehicle 100. The image capture input 518 is in communication with the controller 514 and is configured to instruct the camera 500 to capture an image in response to activation of the image capture input 518 by a user. In some embodiments, the image capture input 518 is arranged on a joystick within the cab interior 42, on a dash of the vehicle 100, or as a soft key on the display 516.

The GPS sensor 520 is configured to monitor and provide a real-time location of the vehicle 100. In some embodiments, the GPS sensor 520 is integrated into the control panel 512. In some embodiments, the GPS sensor 520 is a native sensor included on the vehicle 100 for tracking and monitoring of the vehicle 100. The wireless interface 522 includes a transmitter and receiver for sending and receiving wireless communication signals. The wireless interface 522 can communicate with a remote server or cloud platform 524 using a wireless internet connection (e.g., cellular or Wi-Fi). The remote server or cloud platform 524 is located remotely from the vehicle 100 and can include a variety of cloud-based services or applications configured to store, process, analyze, or otherwise consume data collected from the camera 500 and the controller 514. The remote server or cloud platform 524 can be accessed by various users (e.g., enterprise users, etc.) via control applications.

In the illustrated embodiment, the control panel 512 includes a plurality of exception inputs that are configured to classify a collection exception. Specifically, the control panel 512 includes a first exception input 526, a second exception input 528, a third exception input 530, and an nth exception input 532. In some embodiments, each of the first, second, third, and nth exception inputs 526, 528, 530, 532 are in the form of a push button, a switch, or an equivalent input that is manipulated by a user of the vehicle 100. In some embodiments, the first, second, third, and nth exception inputs 526, 528, 530, 532 are in the form of a soft key on the display 516. In some embodiments, the soft keys on the display 516 that correspond with the first, second, third, and nth exception inputs 526, 528, 530, 532 are shown in response to activation of the image capture input 518. That is, a user can instruct the camera 500 to capture an image of a target area by activating the image capture input 518 and, in response, the display 516 can present the soft keys for the first, second, third, and nth exception inputs 526, 528, 530, 532 so that the user can classify a collection exception that is associated with the captured image.

Each of the first, second, third, and nth exception inputs 526, 528, 530, 532 corresponds with a different collection exception. For example, the first exception input 526 can correspond with a refuse container overflowing, the second exception input 528 can correspond with a refuse container not being present in the target area, the third exception input 530 can correspond with a refuse container being irretrievable, and the nth exception input 532 can correspond with an equivalent status that prevents the vehicle 100 from lifting a refuse container from the target area. The activation of one of the first, second, third, and nth exception inputs 526, 528, 530, 532 generates collection data that includes the corresponding collection exception. The collection data is communicated to the controller 514 and the controller 514 is configured to associate the collection exception with a captured image.

In some embodiments, the control panel 512 does not include the plurality of exception inputs and, instead, the controller 514 is configured to detect and classify the collection exceptions based on the images of a target area captured by the camera 500. For example, in some embodiments, the controller 514 is configured to implement image processing on the captured images to determine if a collection exception is present. In some embodiments, the controller 514 stores a virtual model of a refuse container that is intended to be engaged and lifted by the vehicle 100, and the controller 514 utilizes the virtual model to compare to the refuse container, or lack thereof, in the captured images. If the captured image does not include a refuse container that matches the virtual model, within a predefined tolerance, the controller 514 determines that the refuse container is not present within the target area and classifies this collection exception in collection data that is associated with the captured image. If the captured image includes a refuse container that defines a volume, area, or height that is greater than a predefined threshold of the volume, area, or height defined by the virtual model, the controller 514 determines that the refuse container overflowing and classifies this collection exception in collection data that is associated with the captured image. If the captured image includes an obstruction between the vehicle 100 and the refuse container and/or an orientation of the refuse container is offset greater than a predefined tolerance relative to the virtual model, the controller 514 determines that the refuse container is irretrievable and classifies this collection exception in collection data that is associated with the captured image.

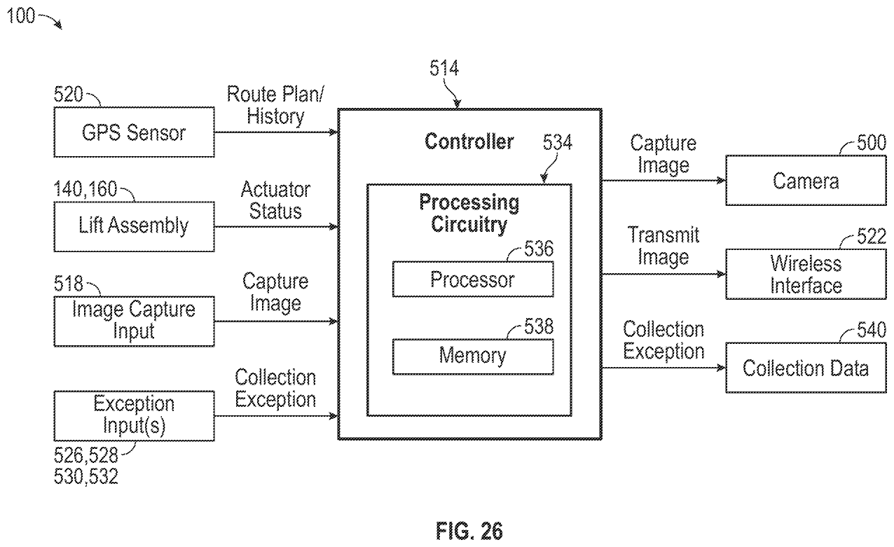

As shown in FIG. 26, the controller 514 includes a processing circuit 534 having a processor 536 and memory 538. The processing circuit 534 can be communicably connected to a communications interface such that the processing circuit 534 and the various components thereof can send and receive data via the communications interface. The processor 536 can be implemented as a general purpose processor, an application specific integrated circuit (“ASIC”), one or more field programmable gate arrays (“FPGAs”), a group of processing components, or other suitable electronic processing components.

The memory 538 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 538 can be or include volatile memory or non-volatile memory. The memory 538 can include database components, object code components, script components, or any other type of information structure for supporting the various activities and information structures described in the present application. According to some embodiments, the memory 538 is communicably connected to the processor 536 via the processing circuit 534 and includes computer code for executing (e.g., by the processing circuit 534 and/or the processor 536) one or more processes described herein.

The controller 514 is in communication with the GPS sensor 520, the lift assembly 140, 160, the image capture input 518, the exception inputs 526, 528, 530, 532, the camera 500, and the wireless interface 522. As described herein, the GPS sensor 520 provides a real-time location of the vehicle 100 during a travel route. In some embodiments, the memory 538 may include a predefined travel route with planned stopping locations along the travel route. The predefined travel route can be programmed into or communicated to (e.g., via the wireless interface 522) the controller 514, or the predefined travel route can be learned by the controller 514 based on historical data from the GPS sensor 520. In some embodiments, the controller 514 is configured to compare the real-time location of the vehicle 100 to the predefined travel route to determine if the vehicle 100 fails to stop at one of the planned stopping locations. If the controller 514 determines that the vehicle 100 failed to stop at one of the planned stopping locations, the controller 514 is configured to automatically instruct the camera 500 to capture an image while passing the planned stopping location. In these embodiments, the image capture input 518 is automatically initiated by the controller 514. The vehicle 100 passing and not stopping at a planned stopping location may be indicative of at least one of the collection exceptions being observed by the user of the vehicle 100 as it passes the planned stopping location (e.g., refuse container not present). The functionality provided by the controller 514 enables images documenting the potential collection exceptions to be automatically captured as the vehicle 100 passes the planned stopping location.

In some embodiments, the controller 514 is configured to determine that the vehicle 100 stopped at one of the planned stopping locations (e.g., via input from the GPS sensor 520) but the lift assembly 140, 160 was not actuated to engage and lift a refuse container. The controller 514 receives an actuator status from the lift assembly 140, 160 to determine if the lift assembly 140, 160 is actuated or remains in a stationary state during a planned stop. If the controller 514 determines that the vehicle 100 stopped and the lift assembly 140, 160 failed to actuate, the controller 514 is configured to automatically instruct the camera 500 to capture an image while at the planned stopping location. In these embodiments, the image capture input 518 is automatically initiated by the controller 514. The vehicle 100 stopping and not actuating the lift assembly 140, 160 may be indicative of at least one of the collection exceptions being observed by the user of the vehicle 100 (e.g., refuse container not present, refuse container overflowing, refuse container irretrievable, etc.), and the controller 514 is configured to automatically capture images and document these potential collection exceptions.

In some embodiments, the controller 514 is configured to receive a manual input, for example, via a user activating the image capture input 518, that instructs the camera 500 to capture an image of a target area. After the camera 500 captures the image, a user classifies the collection exception by activating at least one of the first, second, third, and nth exception inputs 526, 528, 530, 532, which generates collection data 540 that is associated with the captured image and the classified collection exception.

Once an image is captured (either automatically or manually) and a collection exception is classified (either automatically or manually), the controller 514 is configured to generate collection data 540 that is associated with the captured image. The collection data 540 includes at least one of the classified collection exception, a location that the image was captured (e.g., from the GPS sensor 520), or a timestamp when the image was captured. In some embodiments, the collection data 540 includes the classified collection exception, a location that the image was captured (e.g., from the GPS sensor 520), and a timestamp when the image was captured. The controller 514 is configured to transmit the captured image and the associated collection data 540 to the remote server or cloud platform 524 via the wireless interface 522. In this way, for example, the captured images and the associated collection data 540 are stored in a remote location and capable of being viewed and accessed by an enterprise user to verify and document the collection exceptions encountered along a travel route.

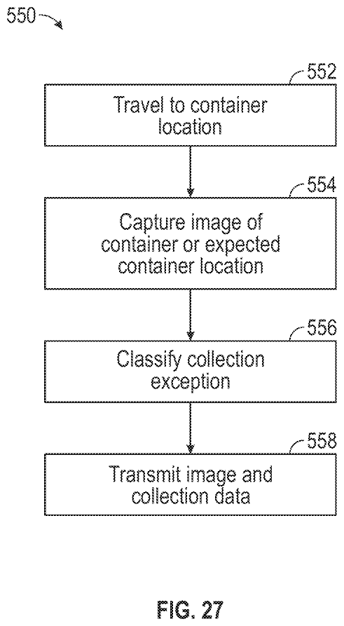

FIG. 27 shows the steps in a method 550 for operating a refuse vehicle (e.g., the refuse vehicle 100) having a camera (e.g., the camera 500). Initially, at step 552, the vehicle 100 travels to a location where a refuse container is expected to reside. In some embodiments, the location is a planned stopping location along a predefined travel route traversed by the vehicle 100. At the location, a target area is defined as an area within which a refuse container is expected to reside so that the lift assembly 140, 160 is capable of engaging and lifting the refuse container to empty the contents of the refuse container into the hopper volume 132. In some embodiments, the target area may include a collection exception that prevents the lift assembly 140, 160 from engaging and lifting a refuse container. At step 554, an image is captured by the camera 500 of the target area of a location (e.g., a planned stopping location along the predefined travel route). In some embodiments, the image capture is initiated by a user manually activating the image capture input 518 (e.g., in response to the user detecting a collection exception). In some embodiments, the image capture is automatically initiated by the controller 514 in response to detecting that the vehicle did not stop at a planned stopping location, or in response to detecting that the vehicle stopped at a planned stopping location but did not actuate the lift assembly 140, 160.

In general, the camera 500 can be instructed, either manually or automatically, to capture an image of a target area in response to a collection exception being present in the target area. Once the image is captured at step 554, the collection exception (e.g., a refuse container is not present, refuse container overflowing, refuse container is irretrievable, etc.) in the target area is classified at step 556. In some embodiments, the collection exception is automatically classified by the controller 514 during image processing of the captured image. In some embodiments, the collection exception is manually classified by a user activating at least one of the first, second, third, and nth exception inputs 526, 528, 530, 532. Once the collection exception is classified at step 556, the captured image and collection data 540 are transmitted to the remote server or cloud platform 524 at step 558. In some embodiments, the captured image and the collection data 540, which includes the GPS location of the captured image, are transmitted as an email or text message to the remote server or cloud platform 524, or to a remote user or customer. For example, the memory 538 can include, or be sent, contact information for each of the customers at the planned stopping locations along the predefined travel route, and the GPS location in the collection data 540 can be correlated with a particular customer. The customer with the collection exception that corresponds with the captured image can sent the captured image and the collection data 540.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A method of operating a refuse vehicle, the method comprising:
capturing an image of a target area, the target area including a collection exception that prevents lifting of a refuse container from the target area;
classifying the collection exception and including the classified collection exception in collection data; and
transmitting the image of the target area and the collection data to a remote server or cloud platform.

2. The method of claim 1, wherein capturing the image of the target area comprises:
a user manually activating a camera to capture the image of the target area.

3. The method of claim 1, wherein capturing the image of the target area comprises:
capturing the image of the target area in response to detecting that the refuse vehicle did not stop at a predefined stopping location.

4. The method of claim 1, wherein capturing the image of the target area comprises:
capturing the image of the target area in response to detecting that the refuse vehicle stopped at a predefined stopping location and failed to actuate a lift assembly.

5. The method of claim 1, wherein the collection exception includes a refuse container not being present at a predefined stopping location.

6. The method of claim 1, wherein the collection exception includes a refuse container being present at a predefined stopping location and overflowing.

7. The method of claim 1, wherein the collection exception includes a refuse container being irretrievable from a predefined stopping location.

8. The method of claim 1, further comprising:
transmitting a GPS location of the image to the remote server or cloud platform.

9. The method of claim 8, further comprising:
correlating the GPS location with contact information for a customer along a planned route.

10. A refuse vehicle comprising:
a chassis;
a cab coupled to the chassis;
a refuse compartment supported by the chassis and including a storage section and a hopper section, the hopper section being arranged between the cab and the storage section;
a lift assembly operable to engage and lift a refuse container;
a camera coupled to a portion of the cab or the refuse compartment; and
a controller including a processor and at least one memory, the controller being in communication with the camera and being configured to:
instruct the camera to capture an image of a target area in response to an image capture input, and
transmit the image and a collection exception to a remote server or cloud platform.

11. The refuse vehicle of claim 10, wherein the camera is coupled to a sidewall of the cab, an external surface of the hopper section, or an external surface of the storage section.

12. The refuse vehicle of claim 10, wherein the collection exception includes a refuse container not being present at a predefined stopping location.

13. The refuse vehicle of claim 10, wherein the collection exception includes a refuse container being present at a predefined stopping location and overflowing.

14. The refuse vehicle of claim 10, wherein the collection exception includes a refuse container being irretrievable from a predefined stopping location.

15. The refuse vehicle of claim 10, wherein the controller is configured to instruct the camera to capture the image in response to:
a user manually activating the camera to capture the image of the target area.

16. The refuse vehicle of claim 10, wherein the controller is configured to instruct the camera to capture the image in response to:
detecting that the refuse vehicle did not stop at a predefined stopping location.

17. The refuse vehicle of claim 10, wherein the controller is configured to instruct the camera to capture the image in response to:
detecting that the refuse vehicle stopped at a predefined stopping location and failed to actuate the lift assembly.

18. The refuse vehicle of claim 10, wherein the controller is further configured to:
transmit a GPS location of the image to the remote server or cloud platform; and
correlate the GPS location with contact information for a customer along a planned route.

19. A method of operating a refuse vehicle, the method comprising:
traveling along a planned route;
capturing an image of a target area in response to:
activating a camera to capture the image of the target area;
detecting that the refuse vehicle did not stop at a predefined stopping location along the planned route; or
detecting that the refuse vehicle stopped at the predefined stopping location and failed to actuate a lift assembly;
classifying a collection exception in the image as:
a refuse container not being present at the predefined stopping location;
a refuse container being present at the predefined stopping location and overflowing; or
a refuse container being irretrievable from the predefined stopping location; and
transmitting the image of the target area and the collection exception to a remote server or cloud platform.

20. The method of claim 19, further comprising:
transmitting a GPS location of the image to the remote server or cloud platform; and
correlating the GPS location with contact information for a customer along the planned route.
